(19) United States
(12) Patent Application Publication
(10) Pub. No.: US 2013/0048041 A1
(43) Pub. Date: Feb. 28, 2013

(54) STANDING ASSIST DEVICE AND SYSTEM

(71) Applicant: Dale Thomas, Riverton, UT (US)

(72) Inventor: Dale Thomas, Riverton, UT (US)

(21) Appl. No.: 13/592,084

(22) Filed: Aug. 22, 2012

Related U.S. Application Data
(60) Provisional application No. 61/526,083, filed on Aug. 22, 2011.

(51) Int. Cl. A61H 3/00

(52) U.S. Cl. 135/66; 135/65

(57) ABSTRACT

A standing assist device is disclosed and described. The device can include a base portion to fixedly mount to a support surface. The device can also include a first handle portion coupled to the base portion and disposed at least partially in a first vertical plane. Additionally, the device can include a second handle portion coupled to the base portion and disposed at least partially in a second vertical plane that is non-coplanar with the first vertical plane, the second handle portion having a lateral extension portion to extend toward a seating location of a user.

### RELATED APPLICATION

This application claims the benefit of U.S. Provisional Application No. 61/526,083, filed Aug. 22, 2011, which is incorporated herein by reference.

### FIELD OF THE INVENTION

The present invention relates generally to human weight bearing devices and, more particularly, to devices for assisting a human to stand or sit, in some cases without an attendant.

### BACKGROUND

Many people have disabilities or mobility difficulties that hinder motions that are part of everyday life. For example, people with medical conditions such as dizziness, Parkinson's disease, arthritis, osteoporosis, or hip surgery recovery can have difficulty steadying themselves when standing up or sitting down. Such people require, or can benefit from, assistance when sitting down or standing up. Typical wall-mounted grab bars are commonly seen in public handicapped toilet stalls or in a shower or bath enclosure to help people maintain balance while standing or maneuvering in order to minimize the chance for slips and falls. However, many seating locations, such as sofas or couches, are not located near a wall. Typical wall-mounted grab bars therefore may not be installed in a useful position for such seating locations. Moreover, typical wall-mounted grab bars are substantially parallel and in close proximity to the supporting wall surface. Thus, the typical wall-mounted grab bars may be of limited effectiveness in situations where a person requires support in a seated position and an additional support when in a standing position.

For these and other reasons, it is desirable to provide a standing assist device and associated system that provides effective support for a user away from a wall and also multiple support handles for different positions of the user.

### SUMMARY

A standing assist device and associated system is disclosed and described. The device can include a base portion to fixedly mount to a support surface. The device can also include a first handle portion coupled to the base portion and disposed at least partially in a first vertical plane. Additionally, the device can include a second handle portion coupled to the base portion and disposed at least partially in a second vertical plane that is non-coplanar with the first vertical plane, the second handle portion having a lateral extension portion to extend toward a seating location of a user.

In one aspect, a standing assist system is provided. The system can include a seat having a seating location for a user and a facing direction. The system can also include a standing assist device. The standing assist device can include a base portion fixedly mounted to a support surface. The standing assist device can also include a first handle portion coupled to the base portion and disposed at least partially in a first vertical plane. Additionally, the standing assist device can include a second handle portion coupled to the base portion and disposed at least partially in a second vertical plane that is non-coplanar with the first vertical plane, the second handle portion having a lateral extension portion extending toward the seating location for the user.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments and are not, therefore, to be considered limiting of its scope. And furthermore, it will be readily appreciated that the components, as generally described and illustrated in the figures herein, could be arranged and designed in a wide variety of different configurations.

FIG. 1 is perspective view of a standing assist system, in accordance with an example of the present disclosure.

FIG. 2 is a side view of a standing assist system and a close-up view of a base support of a standing assist device, in accordance with an example of the present disclosure.

FIG. 3A is a perspective view of a standing assist system, in accordance with another example of the present disclosure.

FIG. 3B is a perspective view of a standing assist system, in accordance with yet another example of the present disclosure.

FIG. 4A is a perspective view of a standing assist system having a bed for a seat, in accordance with an example of the present disclosure.

FIG. 4B is a side view of the standing assist system of FIG. 4A.

FIG. 5A is a perspective view of a standing assist system having a recliner for a seat, in accordance with an example of the present disclosure.

FIG. 5B is a perspective view of the standing assist system of FIG. 5A with the recliner extended to a reclined position.

FIG. 6A is a perspective view of a standing assist system having a toilet for a seat, in accordance with an example of the present disclosure.

FIG. 6B is a perspective view of the standing assist system of FIG. 6A.

FIG. 7 is a perspective view of a standing assist device having a support base, in accordance with an example of the present disclosure.

### DETAILED DESCRIPTION

Reference will now be made to exemplary embodiments and specific language will be used herein to describe the same. It will nevertheless be understood that no limitation of the scope of the present invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

It must be noted that, as used in this specification and the appended claims, the singular forms “a,” “an,” and “the” include plural referents unless the context clearly dictates otherwise. Thus, for example, reference to “a standing assist device” includes one or more of such standing assist devices and reference to “a base portion” includes reference to one or more of such base portions.

In describing and claiming the present invention, the following terminology will be used in accordance with the definitions set forth below.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, “about” refers to a degree of deviation based on experimental error typical for the particular property identified. The latitude provided the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” shall expressly include “exactly,” consistent with the discussion below regarding ranges and numerical data.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and 200, but also to include individual sizes such as 2, 3, 4, and sub-ranges such as 10 to 50, 20 to 100, etc.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims unless otherwise stated. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

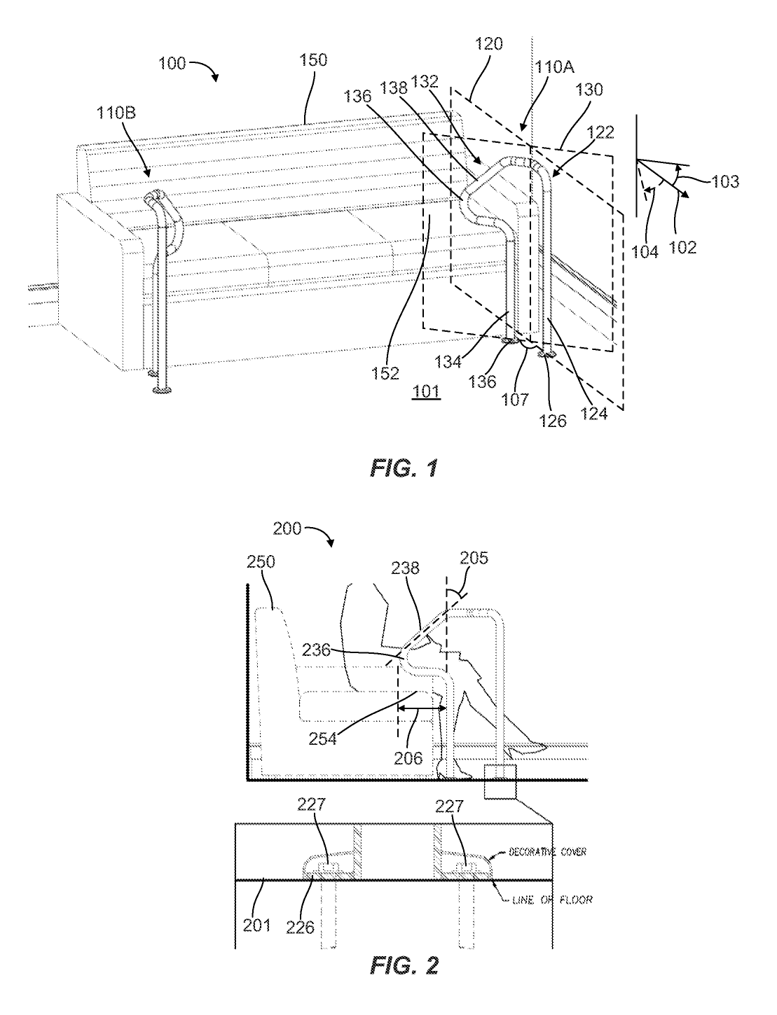

With reference to FIG. 1, illustrated is a standing assist system 100. The system can include a seat 150, such as a sofa, and at least one standing assist device 110A, 1108. The seat can have a seating location 152 for a user and a facing direction 102. The standing assist device can have a base portion 124, 134 to fixedly mount to a support surface 101, a first handle portion 122, and a second handle portion 132. The second handle portion 132 can have a lateral extension portion 136 extending toward the seating location 152 for a user.

The first handle portion 122 and the second handle portion 132 can be coupled to the base portion 124, 134. In one aspect, the first handle portion 122 and the second handle portion 132 can comprise a single unitary structure. Alternatively, the first handle portion 122 and the second handle portion 132 can comprise separate structures permanently or removably coupled to one another. The standing assist device can be designed to support loads applied by a user. For example, the standing assist device can be designed to withstand a 300 pound lateral load applied at a top handle portion of the device.

The first handle portion 122 and the second handle portion 132 can comprise any suitable cross-sectional shape. Suitable shapes can include shapes that are comfortable or easy for a user to grasp. For example, the first handle portion 122 and/or the second handle portion 132 can have a cross-sectional shape comprising a circle, an oval, a rectangle, or combinations thereof. Furthermore, the first handle portion 122 and/or the second handle portion 132 can comprise a tubular construction. The standing assist device can be made of any suitable structural material such as a metal, polymer, composite, wood, stone, concrete, etc. The handle portion can be sized to allow the user to comfortably and securely grip the standing assist device. For example, the handle portion can have a diameter of between about 0.75 inch and about 3 inches. In one aspect, the diameter is between about 1.25 inches and about 1.5 inches. The top handle portion can be vertically positioned to allow a user to reach the handle portion when seated and when standing. For example, the top handle portion can be located between about 30 inches and about 38 inches above the support surface 101.

The standing assist device can also include a grip on the handle portion for comfort and/or enhanced friction. The grip can include texturing such as knurling or materials such as a foam rubber or other elastomer.

The first handle portion 122 and the second handle portion 132 can each be disposed in a separate plane. For example, the first handle portion 122 can be disposed at least partially in a first vertical plane 120 and the second handle portion 132 can be disposed at least partially in a second vertical plane 130. The second vertical plane 130 is non-coplanar with the first vertical plane 120. For example, the first vertical plane 120 and the second vertical plane 130 can intersect at an angle 107 of between about 90 degrees and about 179 degrees. The first handle portion and the second handle portion can thus provide a variety of grip positions for the user. In addition, the angle between the planes can create an opening or “pocket” for the user to step into for support with minimal interference between the user's feet and legs with the base portions 124, 134 of the standing assist device.

The base portion 124 can include a base support 126 and base portion 134 can include a base support 136 to interface with, and fixedly mount to the support surface 101. The base support 126 can be disposed at least partially in the first vertical plane 120 and the second base support 136 can be disposed at least partially in the second vertical plane 130. The support surface can comprise a floor, a deck, a step, a platform, or any other suitable support surface. In one aspect, discussed hereinafter, the support surface can comprise a foot support structure that is configured to rest on a floor or other suitable surface.

In one aspect of the standing assist system 100, the standing assist device 110A can be oriented such that the first vertical plane 120 is parallel to the facing direction 102 of the seat 150. This orientation can be such that the second vertical plane 130 is at an angle 103 relative to the facing direction 102 of the seat 150. Thus, in one aspect, the second vertical plane 130 can be between an angle 103 of greater than 0 degrees and about 90 degrees relative to the facing direction 102 of the seat 150. In a more particular aspect, the standing assist device can be oriented such that the second vertical plane 130 is at an angle 103 of between about 10 degrees and about 75 degrees relative to the facing direction 102 of the seat 150. In an even more particular aspect, the standing assist device can be oriented such that the second vertical plane 130 is at an angle 103 of between about 20 degrees and about 60 degrees relative to the facing direction 102 of the seat 150. It should be recognized that an angle of the first vertical plane or second vertical plane relative to the facing direction 102 of the seat 150 can be measured from either side of the facing direction 102, as illustrated by angle 103 and angle 104.

With reference to FIG. 2, illustrated is a side view of a standing assist system 200. As shown, lateral extension portion 236 can extend over at least a portion 254 of the seat 250. In one aspect, the lateral extension portion extends laterally 206 at least six inches. In one aspect, the lateral extension portion 236 can include a vertically angled portion 238 for the user to grasp. The vertically angled portion can provide an additional grip location for the user and can position a grip location in close proximity to the user when the user is seated. The vertically angled portion can be at an angle 205 of between about 0 degrees and about 89 degrees relative to vertical. The vertically angled portion can present a configuration that allows the user to ease into a standing position. Additionally, the figure illustrates that base support 226 can fixedly mount to support surface 201 with coupling features 227, such as fasteners.

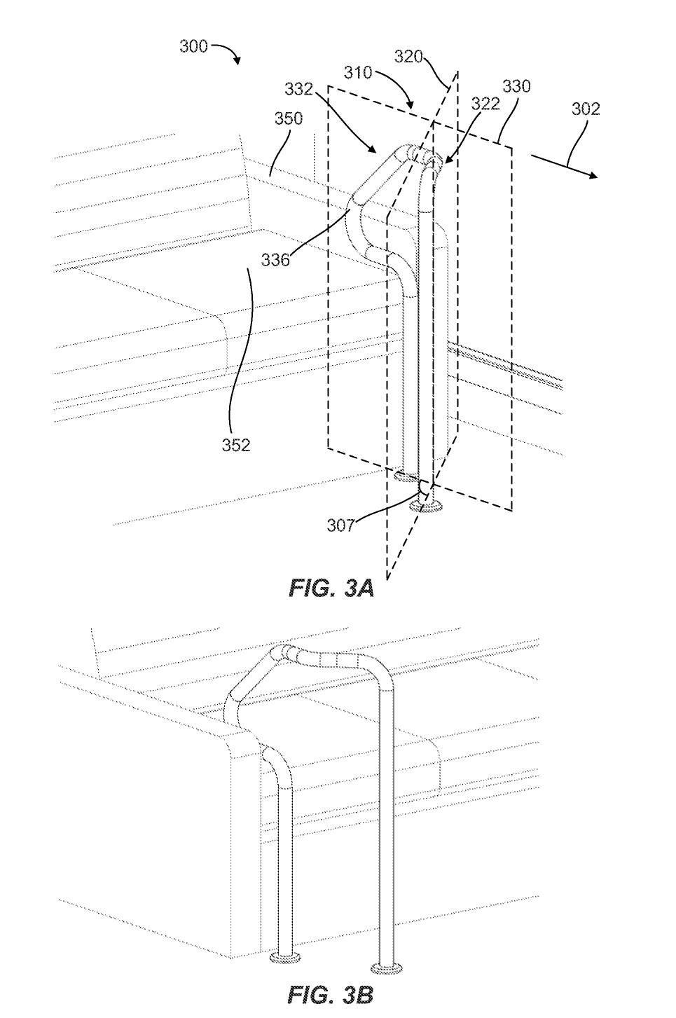

With reference to FIGS. 3A and 3B, illustrated is a standing assist system 300. These figures illustrate that a standing assist device 310 can be oriented such that a second vertical plane 330 is parallel to a facing direction 302 of a seat 350. Thus, in other words, the second vertical plane 330 can be about 0 degrees relative to the facing direction 302 of the seat 350.

This orientation can position second handle portion 332 (disposed at least partially in the second vertical plane 330) near a side of the user's seating position 352 and first handle portion 322 (disposed at least partially in a first vertical plane 320) in front of the user's seating position 352. Thus, with the first handle portion angled in front of the seating location 352, the user can grasp the second handle portion 332 to get out of the seat and then grasp the first handle portion 322 to move away from the seat, which can provide a certain amount of available support in front of the user when the user is moving away from the seat. This orientation can also allow the user a chance to gain balance before venturing away from the seat and the support of the standing assist device 310.

In this orientation, the angle 307 between the first vertical plane 320 and the second vertical plane 330 creates a “cradle” that can provide the user with physical support benefits as well as psychological support benefits. For a user that is unsure about balance and strength, the standing assist device can be psychologically comforting by providing the user with a feeling that there is a support to catch the user in case of a forward fall and the side and forward supports can provide support not only when arising from the seat but also when venturing away from the seat.

It should be recognized that a lateral extension portion extending “toward” a seating location of a user does not mean that the lateral extension portion extends directly to the actual seating location of a user. The term “toward” is used in a more general sense herein. For example, in FIG. 3A the lateral extension portion 336 is directed parallel to the facing direction 302 of the seat 350, but is offset to a side of where a user would actually sit at seating location 352. Nevertheless, this example illustrates the lateral extension portion 336 extending toward the seating location 352 of the user.

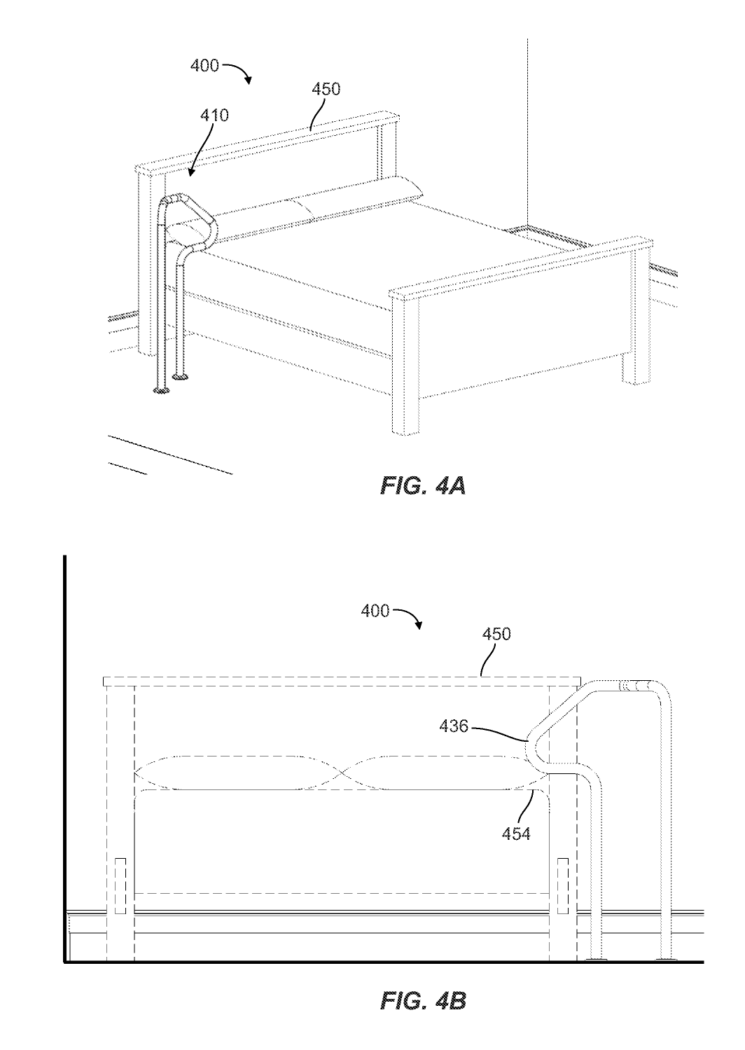

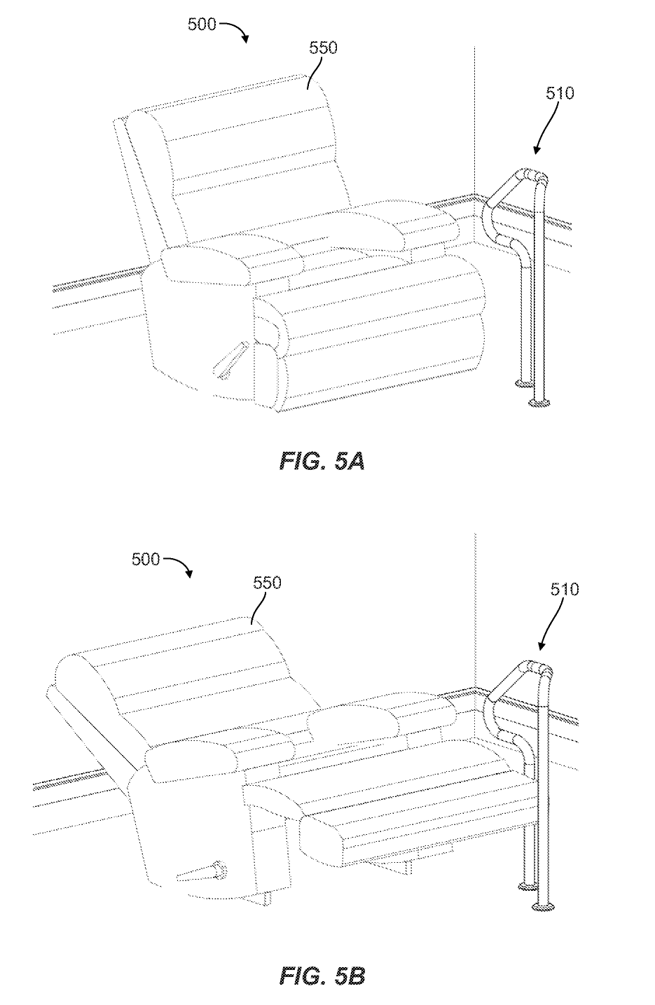

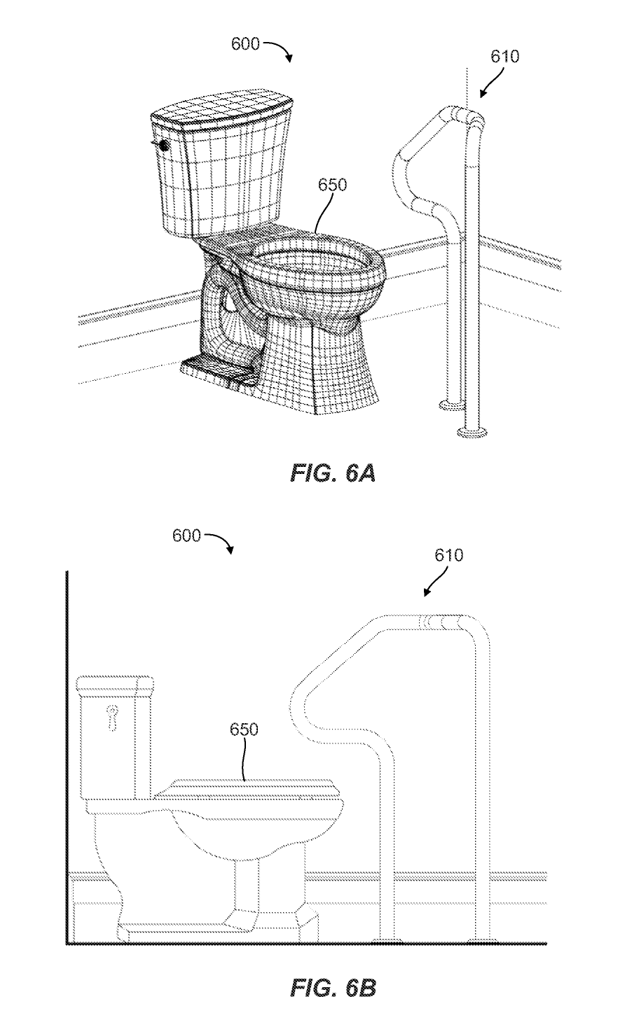

FIGS. 4A-6B illustrate, among other things, several different examples of a seat of a standing assist system. For example, FIGS. 4A and 4B illustrate a standing assist system 400 with a bed 450 serving as a seat. Standing assist device 410 is shown with a lateral extension portion 436 extending over at least a portion 454 of the seat 450. In another example, FIGS. 5A and 5B illustrate a standing assist system 500 with a recliner 550 serving as a seat. Standing assist device 510 is shown positioned such that the recliner 550 can extend to a reclined position without interference with the standing assist device 510. In an additional example, FIGS. 6A and 6B illustrate a standing assist system 600 with a toilet 650 serving as a seat. Standing assist device 610 is shown positioned to allow access and use of the toilet without interference while being positioned in close proximity to the toilet so as to be effective as a support for the user when arising from the toilet.

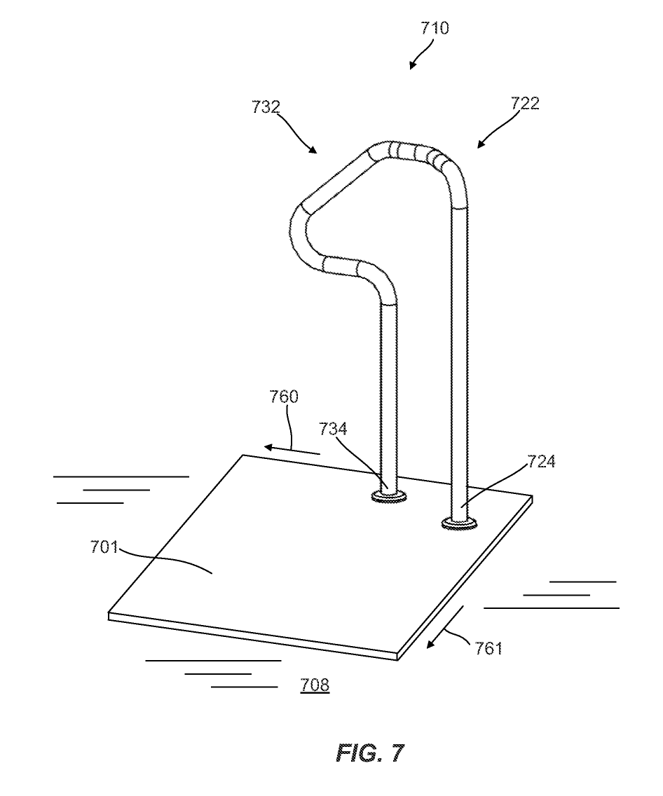

Illustrated in FIG. 7 is another example of a standing assist device 710, aspects of which may be incorporated in any of the standing assist systems disclosed herein. As with other standing assist devices of the present disclosure, the base portion 724, 734 of the device 710 can be fixedly mounted to a support surface. However, in this case, the support surface can comprise a foot support structure 701 adapted to be disposed on a floor 708 or other suitable surface. In one aspect, the foot support structure can rest on the floor and be fixedly attached to the floor. In another aspect, the foot support structure can merely sit on the floor without attachment to the floor. The latter case can facilitate mobility of the standing assist device, in that the device can be readily movable from one location to another. This can be useful when the device is only temporarily needed at a given location or when it is desirable to avoid the effort needed to permanently attach the device or to avoid marring the floor to permanently install the device. The foot support surface can be a planar member such as a plate, although other shapes may be useful.

To facilitate use of the standing assist device 710 without attaching the foot support structure 701 to the floor 708, the foot support structure can be configured to extend in one or both of directions 760, 761 toward a seating location of a user. In this way, the user can step or stand on the foot support structure while using at least one of a first handle portion 722 and a second handle portion 732 to assist in standing up. With the foot support structure supporting at least a portion of the user's weight, the foot support structure can be substantially maintained in position on the floor without being attached to the floor. Optionally, a bottom surface of the foot support structure can be layered with a rubber, foam or polymeric matt to increase frictional engagement with the floor 708. The foot support structure can be dimensioned in directions 760, 761 sufficient to allow the user to put one or both feet on the foot support structure while using the device to stand up.

Moreover, the extension of the foot support structure in at least one of directions 760, 761 toward the user's seating location can be configured to resist tip over of the device when the user is pulling on the handle portions to stand up. Therefore, the combination of the foot support structure extending toward the user's seating location and the user's weight on the foot support structure can enhance stability of the standing assist device during use without attachment to the floor. In one non-limiting example, the base portions 724, 734 of the device 710 can be fixed in an offset position adjacent an edge of the foot support structure 701. In such configurations, the foot support structure can extend widthwise (i.e. along direction 761) along a foot placement area a distance which is at least a height of base portion 734. For example, this foot placement area can range from about 22 inches to about 36 inches in width. For seating configurations, the height of the device can often range from about 32 inches to about 46 inches. Additionally, the mass of the foot support structure and the distribution of mass in the foot support structure can be configured to enhance the stability of the device.

The angle between the planes of the first and second handle portions 722, 734, as well as the vertically angled portion of the second handle portion 732, can present a configuration that allows the user to ease into a standing position. This can be beneficial because with the standing assist device disclosed herein, the user can stand without resorting to rocking or other physical movements that can injure or cause instability of the user once upright. In other words, no abrupt movements are necessary in order for the user to stand that may cause momentum to shift the user's upper body over the handle portions. This can be particularly important when the foot support structure is merely resting, unattached, on the floor, which may be susceptible to toppling over if abrupt movements were necessary for the user to stand.

It should be recognized that the base portions 724, 734 can be fixedly mounted to any portion of the foot support structure 701, such that the base portions can reside in a corner, along an edge, in the middle, or anywhere else relative to the foot support structure. It should also be recognized that the foot support structure can have any suitable form, and that the plate or sheet form shown in the figure is for illustration only, and is not intended to be limiting.

In one aspect, the foot support structure 701 can include features or materials to interface with the floor or other suitable surface. For example, such features or materials can include feet, pads, glides, hook and loop fasteners, friction enhancing materials or features, or any other desirable feature or material. In another aspect, the foot support structure can include features or materials to interface with a foot of the user. For example, such features or materials can include friction enhancing materials or features, padding, a cushion, carpet, tile, or any other desirable feature or material.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. Any steps recited in any method or process claims may be executed in any order and are not limited to the order presented in the claims. Accordingly, the scope of the invention should be determined solely by the appended claims and their legal equivalents, rather than by the descriptions and examples given above.

What is claimed is:

1. A standing assist device, comprising:
a base portion to fixedly mount to a support surface;
a first handle portion coupled to the base portion and disposed at least partially in a first vertical plane; and
a second handle portion coupled to the base portion and disposed at least partially in a second vertical plane that is non-coplanar with the first vertical plane, the second handle portion having a lateral extension portion to extend toward a seating location of a user.

2. The standing assist device of claim 1, wherein the base portion comprises at least one base support to interface with, and fixedly mount to the support surface.

3. The standing assist device of claim 2, wherein a first base support is disposed at least partially in the first vertical plane and a second base support is disposed at least partially in the second vertical plane.

4. The standing assist device of claim 1, wherein the lateral extension portion includes a vertically angled portion for the user to grasp.

5. The standing assist device of claim 4, wherein the vertically angled portion is between about 0 degrees and about 89 degrees relative to vertical.

6. The standing assist device of claim 1, wherein the first vertical plane and the second vertical plane intersect at an angle of between about 90 degrees and about 179 degrees.

7. The standing assist device of claim 1, wherein the first handle portion and the second handle portion comprise a single unitary structure.

8. The standing assist device of claim 1, wherein at least one of the first handle portion and the second handle portion have a cross-sectional shape comprising a circle, an oval, a rectangle, or combinations thereof.

9. The standing assist device of claim 1, wherein at least one of the first handle portion and the second handle portion comprise a tubular construction.

10. The standing assist device of claim 1, wherein the lateral extension portion extends laterally at least six inches.

11. The standing assist device of claim 1, wherein the device further comprises the support surface and the base portion is fixedly mounted to the support surface, and the support surface comprises a foot support structure adapted to be disposed on a floor without attachment to the floor.

12. A standing assist system, comprising:
a seat having a seating location for a user and a facing direction; and
a standing assist device having
a base portion fixedly mounted to a support surface,
a first handle portion coupled to the base portion and disposed at least partially in a first vertical plane, and
a second handle portion coupled to the base portion and disposed at least partially in a second vertical plane that is non-coplanar with the first vertical plane, the second handle portion having a lateral extension portion extending toward the seating location for a user.

13. The standing assist system of claim 12, wherein the standing assist device is oriented such that the first vertical plane is parallel to the facing direction of the seat.

14. The standing assist system of claim 12, wherein the standing assist device is oriented such that the second vertical plane is parallel to the facing direction of the seat.

15. The standing assist system of claim 12, wherein the standing assist device is oriented such that the second vertical plane is at an angle of between about 0 degrees and about 90 degrees relative to the facing direction of the seat.

16. The standing assist system of claim 15, wherein the standing assist device is oriented such that the second vertical plane is at an angle of between about 10 degrees and about 75 degrees relative to the facing direction of the seat.

17. The standing assist system of claim 16, wherein the standing assist device is oriented such that the second vertical plane is at an angle of between about 20 degrees and about 60 degrees relative to the facing direction of the seat.

18. The standing assist system of claim 12, wherein the first vertical plane and the second vertical plane intersect at an angle of between about 90 degrees and about 179 degrees.

19. The standing assist system of claim 12, wherein the lateral extension portion extends over at least a portion of the seat.

20. The standing assist system of claim 12, wherein the lateral extension portion includes a vertically angled portion for the user to grasp.

21. The standing assist system of claim 20, wherein the vertically angled portion is between about 0 degrees and about 89 degrees relative to vertical.

22. The standing assist system of claim 12, wherein the support surface comprises a planar foot support structure adapted to be disposed on a floor.
